(19) United States
(12) Patent Application Publication
(10) Pub. No.: US 2022/0244718 A1
(43) Pub. Date: Aug. 4, 2022

(54) METHOD FOR TOLERANCE ANALYSIS, SYNTHESIS, AND COMPENSATOR SELECTION

(71) Applicant: Prateek Jain, Pasadena, CA (US)

(72) Inventor: Prateek Jain, Pasadena, CA (US)

(73) Assignee: Prateek Jain, Pasadena, CA (US)

(21) Appl. No.: 17/648,672

(22) Filed: Jan. 22, 2022

Related U.S. Application Data
(60) Provisional application No. 63/199,773, filed on Jan. 24, 2021.

(51) Int. Cl. G05B 23/02; G06F 17/16; G06F 5/01

(52) U.S. Cl. CPC G05B 23/0281; G06F 5/01; G06F 17/16

(57) ABSTRACT

Algorithm for tolerance analysis, allocation, and synthesis, also known as tolerance budgeting, is discussed. Also discussed is a metric to rank compensators for a system. It is based on the system Jacobian and the inner product of the output vector error as the tolerancing criterion. These tolerances are calculated by fitting an appropriate, axis aligned multidimensional Orthotope within an ellipsoid like region that is not necessarily axis aligned.

### FIELD OF THE INVENTION

This invention relates to the task of tolerancing.

### BACKGROUND OF THE INVENTION

Tolerancing is necessary in many fields, from mathematical modeling of systems to design of systems that will be manufactured. For example, an optical imaging system or a mechanical design like that of an aircraft engine. The system under design can be described by a set of input parameters which will have a nominal value under ideal conditions. Example of such parameters can be the thickness of a part, a coefficient describing the shape of a surface, etc. However, these parameters can have errors. In other words the system will be most likely perturbed from its nominal state. Apart from the input parameters, the system can also be characterized by a set of output parameters that too will have some nominal value. These parameters could be for example a positive gap in the assembly to avoid mechanical interference, or a ray optical path length affecting the image quality in an imaging system. However, when the system is in a perturbed state, these output parameters will also have errors.

The error in the input parameters is some times characterized by probability distribution functions, or definite upper and lower bounds. The set of output parameters is allowed a range of deviation from the nominal and a perturbed system with its output parameters within this range is considered acceptable. In many cases provisions are made so that the perturbed system can be corrected by adjusting some of the input parameters till the output parameters fall within the nominal range. This alignment is called compensation and the adjustable parameters are called compensators. The task of a designer is to make sure that the system is tolerant to the errors in the input parameter so that the error in the output parameter set is within specifications. This is achieved by a proper tolerance analysis and allocation exercises. Tolerance analysis is the estimation of the error in the output parameters based in the input errors. Tolerance allocation is the process of assigning tolerances, or allowed error range, for each of the input parameter such that output errors are under specification. This allocation process involves an iterative trial and error approach in which the tolerances are adjusted and tolerance analysis performed till the expected output errors are within specification. Often, this involves Monte Carlo simulations. Tolerance analysis itself can be computationally demanding and the entire process can take time. Tolerance synthesis on the other hand is the automatic allocation of tolerances.

### OBJECTS OF THE INVENTION

It is the object of this invention to address the three topics, of tolerance analysis, tolerance synthesis, and disclose a guide to selecting optimum compensators.

### SUMMARY OF THE INVENTION

For this discussion, the system will be assumed to behave linearly with perturbations. This is a reasonable assumption as the expected errors in the input parameters is invariable very small. Obviously, such a requirement is not necessary for systems that are linear. With this assumption, the tools of linear algebra are utilized to arrive at a computationally efficient way to calculate the effect of the perturbations on the output parameters. It will be shown that the task of allocating tolerances transforms into the task of fitting a multi-dimensional axis aligned cuboid, also called an orthotope, inside an ellipsoid. An algorithm for fitting this orthotope will also be disclosed. Since the effect of compensators will be incorporated from the onset, this will make it possible to arrive at a metric for determining the efficacy of the choice of the compensators.

### BRIEF DESCRIPTION OF THE DRAWINGS

For a more complete understanding of the invention, reference is made to the following description and accompanying drawings, in which:

FIG. 1 Illustrates the situation for a 3 dimensional system with one compensator that is aligned to one of the degrees of freedom, reducing the problem to 2D;

FIG. 2 Illustrates the situation for a 3 dimensional system with one compensator that is aligned to one of the degrees of freedom and when one eigen value of matrix R is close to or equal to zero;

FIG. 3 A 2 dimensional illustration of the optimization process to fit the maximum volume Orthotope inside the ellipsoid; and

FIG. 4 Ellipsoid and Orthotope with a constraint on the output vector.

### DETAILED DESCRIPTION OF THE PREFERRED EMBODIMENTS

For the following discussion it will be assumed that a boldface lower case character represents a column vector and a boldface upper case character represents a matrix, and an individual element is represent by the corresponding non-boldface character with the element index in the subscript, and for matrices the first index is the row number. Consider a system represented by a vector r, each element of which is a nominal input parameter. Correspondingly, let z₀ be the vector containing the nominal values of output parameters of the system. However, every element of r can have an error associated with it, let v be the vector that contains these errors. The perturbed system is represented by r+v and the corresponding output vector is z. Under small perturbations, v is small and the system can be assumed to be linear. And z is given by equation (1).

$$z = {z}_{0} + J v \qquad ( 1 )$$

Here J is the system Jacobian or the sensitive matrix where Jᵢⱼ=∂zᵢ/∂rⱼ. J is not necessarily a square matrix as the number of elements in v and z may not be same. The number of degrees of freedom of the system is the number of elements in the vector v. Tolerances assigned to the individual elements rᵢ define the region that v can span. For the tolerancing criterion, an upper limit is imposed on the inner product z′z, where z′ is the transpose of z. Let z′z=w². This requirement is represented by equation (2).

$${z}^{′} z \leq {w}_{0}^{2} \qquad ( 2 )$$

With respect to z₀, there are two situations. Firstly, if z₀ represents the as designed nominal output vector, then it can be simply subtracted from equation (1), and this is equivalent to shifting the origin to z₀ in the output vector space. In this case z is the vector representing the difference from nominal. However, sometimes the requirement is to have z=0 and yet the as designed vector z₀ is not zero. This second situation arises in, for example, imaging systems design. In such designs the individual z, can be for example the optical path length errors of the rays. These must all be zero for good imaging, however, during the design phase, the designer usually has control over only a subset of the parameters that form the vector v. Hence it is likely that the full gamut of the degrees of freedom offered by v allows for a new position of the system, represented by v^{(l)}, where z′z<z₀′z₀. This second case which is more general than the first one, is considered in the following discussion.

Let the number of independent compensators for the system be N. A compensator can either be an individual adjustment of a particular vᵢ or a linear combination of such adjustments. In either case, a compensator can be represented by a unit vector in the vector space of v. A magnitude along this direction represents the adjustment applied to the system. Let the direction of the n'th compensator be represented by the unit vector c⁽ⁿ⁾ and its magnitude be γ⁽ⁿ⁾. In the presence of compensation, equation (1) changes to equation (3).

$$z = {z}_{0} + J ( v - {\sum }_{n = 1}^{N} {γ}^{( n )} {c}^{( n )} ) \qquad ( 3 )$$

For compactness, the index of the summation operator will be omitted when there is no ambiguity. Obviously, the task of tolerancing becomes trivial if N approaches the number of dimensions of v. It is assumed that N is less than the number of elements in v.

$$\begin{matrix}{w}^{2} = {z}^{′} z \\ = {[ {z}_{0} + J ( v - \sum {γ}^{( n )} {c}^{( n )} ) ]}^{′} [ {z}_{0} + J ( v - \sum {γ}^{( n )} {c}^{( n )} ) ] \\ = {z}_{0}^{′} {z}_{0} + 2 {z}_{0}^{′} J ( v - \sum {γ}^{( n )} {c}^{( n )} ) + \\ {( v - \sum {γ}^{( n )} {c}^{( n )} )}^{′} {J}^{′} J ( v - \sum {γ}^{( n )} {c}^{( n )} )\end{matrix} \qquad ( 4 )$$

Let J′J=D, a symmetric matrix. Optimum compensation is achieved when w² is minimized. This will happen when all the partial derivatives ∂w²/∂γ⁽ⁱ⁾ are simultaneously zero.

$$\frac{\partial {w}^{2}}{\partial {γ}^{( i )}} = 0 \\ ⇒ - 2 {z}_{0}^{′} J {c}^{( i )} - 2 {v}^{′} {Dc}^{( i )} + 2 \sum {γ}^{( n )} {c}^{′ ( n )} {Dc}^{( i )} = 0 \\ \sum {γ}^{( n )} {c}^{′ ( n )} D {c}^{( i )} = {v}^{′} {Dc}^{( i )} + {z}_{0}^{′} {Jc}^{( i )} \qquad ( 5 )$$

Conclusion of equation (5) represents a total of N linear equations. These can be represented in matrix notation like so.

$$M γ = a \qquad ( 6 )$$

Here M is a N×N symmetric matrix and Mᵢⱼ=c′^{(j)}Dc⁽ⁱ⁾, i'th element of γ is γ⁽ⁱ⁾, and aᵢ=v′Dc⁽ⁱ⁾+z₀′Jc⁽ⁱ⁾. Let the inverse of M be designated by M⁻¹ which is also a symmetric matrix. The optimum magnitude of the compensators is now obtained from equation (7). The equations can be represented in more compact form by noting that M=C′DC, where C is a matrix, the i'th column of which is the vector c⁽ⁱ⁾. Additionally, equation (6) can also be arrived at by noting that at the optimum compensation the gradient ∇w² is orthogonal to each of the compensators. Here ∇ denotes the multidimensional gradient operator. Obviously, the chosen compensators must be independent in their effect and they also cannot belong to the null space of J as that would not only be ineffective but furthermore, M⁻¹ will not exist.

$${γ}^{( i )} = {\sum }_{j} {M}_{ij}^{- 1} {a}_{j} \qquad ( 7 )$$

The inner product of the output vector of the compensated system, w̅², can be calculated by using the conclusion of equation (5) in equation (4).

$${\overline{ω}}^{2} = {z}_{0}^{′} {z}_{0} + 2 {z}_{0}^{′} Jv + {v}^{′} Dv - ( {\sum }_{i} {γ}^{( i )} ( {z}_{0}^{′} J + {v}^{′} D ) {c}^{( i )} ) \qquad ( 8 )$$

Solution from equation (7) can be inserted in the last term of equation (8), as follows.

$${\sum }_{i} {γ}^{( i )} ( {z}_{0}^{′} J + {v}^{′} D ) {c}^{( i )} = {\sum }_{i} ( {\sum }_{j} {M}_{ij}^{- 1} {a}_{j} ) ( {z}_{0}^{′} J + {v}^{′} D ) {c}^{( i )} = {\sum }_{i , j} ( {M}_{ij}^{- 1} ( {z}_{0}^{′} J + {v}^{′} D ) {c}^{( j )} ( {z}_{0}^{′} J + {v}^{′} D ) {c}^{( i )} ) = {\sum }_{i , j} {M}_{ij}^{- 1} ( {z}_{0}^{′} {Jc}^{( j )} {c}^{′ ( i )} {J}^{′} {z}_{0} + 2 {z}_{0}^{′} {Jc}^{( j )} {c}^{′ ( i )} Dv + {v}^{′} {Dc}^{( j )} {c}^{′ ( i )} Dv ) \qquad ( 9 )$$

Substituting the results of equation (9) back into equation (8) and collecting like terms, w̅² is obtained as shown in equation (10). The identity matrix is denoted by I.

$${\overline{w}}^{2} = {v}^{′} Qv + Lv + b \\ where \\ \begin{matrix}Q = D - {\sum }_{i , j}^{N} {M}_{ij}^{- 1} {Dc}^{( j )} {c}^{′ ( i )} D \\ = D - {DCM}^{- 1} {C}^{′} D\end{matrix} \\ \begin{matrix}L = 2 {z}_{0}^{′} J - 2 {\sum }_{i , j}^{N} {M}_{ij}^{- 1} {z}_{0}^{′} {Jc}^{( j )} {c}^{′ ( i )} D \\ = 2 {z}_{0}^{′} J ( I - {\sum }_{i , j}^{N} {M}_{ij}^{- 1} {c}^{( j )} {c}^{′ ( i )} D )\end{matrix} \\ and \\ b = {z}_{0}^{′} ( I - {\sum }_{i , j}^{N} {M}_{ij}^{- 1} {Jc}^{( j )} {c}^{′ ( i )} {J}^{′} ) {z}_{0} \qquad ( 10 )$$

Equation (10) is a general quadratic form in v. Matrix Q is symmetric and positive semi-definite since w̅² represents the inner product of the residual output vector after optimum compensation of the perturbed system. However, v has many degrees of freedom and a particular v, called v^{(l)}, can be estimated at which w̅² is minimized to wₗ². At this minimum, the gradient of w̅² is zero. Let V denote the multidimensional gradient operator.

$$∇ ( {\overline{w}}^{2} ) = ∇ ( {v}^{′} Qv + Lv + b ) = 2 Qv + {L}^{′} \\ 2 {Qv}^{( l )} + {L}^{′} = 0 ⇒ ( D - {\sum }_{i , j}^{N} {M}_{ij}^{- 1} {Dc}^{( j )} {c}^{′ ( i )} D ) {v}^{( l )} + ( I - {\sum }_{i , j}^{N} {M}_{ij}^{- 1} {Dc}^{( i )} {c}^{′ ( i )} ) {J}^{′} {z}_{0} = 0 \\ {Dv}^{( l )} = - {J}^{′} {z}_{0} \\ {v}^{( l )} = - {( {J}^{′} J )}^{- 1} {J}^{′} {z}_{0} \qquad ( 11 )$$

Equation (11) is the well known least squares equation and its solution gives the optimum value v^{(l)}. This solution can be inserted in equation (10) to obtained wₗ², as follows.

$${w}_{l}^{2} = {v}^{′ ( l )} {Qv}^{( l )} + {Lv}^{( l )} + b \\ {v}^{′ ( l )} {Qv}^{( l )} = {z}_{0}^{′} {JD}^{- 1} {J}^{′} {z}_{0} - {\sum }_{i , j}^{N} {M}_{ij}^{- 1} {z}_{0}^{′} {Jc}^{( j )} {c}^{′ ( i )} {J}^{′} {z}_{0} \\ {Lv}^{( l )} = - 2 {z}_{0}^{′} {JD}^{- 1} {J}^{′} {z}_{0} + 2 {\sum }_{i , j}^{N} {M}_{ij}^{- 1} {z}_{0}^{′} {Jc}^{( j )} {c}^{′ ( i )} {J}^{′} {z}_{0} \\ b = {z}_{0}^{′} {z}_{0} - {\sum }_{i , j}^{N} {M}_{ij}^{- 1} {z}_{0}^{′} {Jc}^{( j )} {c}^{′ ( i )} {J}^{′} {z}_{0} \\ {w}_{l}^{2} = {z}_{0}^{′} ( I - {JD}^{- 1} {J}^{′} ) {z}_{0} \qquad ( 12 )$$

The origin for the vector v can be shifted to v^{(l)}. The new vector u is given by v−v^{(l)}. With this origin shift, equation (10) transforms as follows to equation (13)

$$\begin{matrix}{\overline{w}}^{2} = {( u + {v}^{( l )} )}^{′} Q ( u + {v}^{( l )} ) + L ( u + {v}^{( l )} ) + b \\ = {u}^{′} Qu + ( 2 {v}^{′ ( l )} Q + L ) u + {v}^{′ ( l )} {Qv}^{( l )} + {Lv}^{( l )} + b \\ = {u}^{′} Qu + {L}^{( l )} u + {w}_{l}^{2}\end{matrix} \\ and \\ \begin{matrix}{L}^{( l )} = & 2 {v}^{′ ( l )} Q + L \\ = & - 2 {z}_{0}^{′} {JD}^{- 1} ( D - {\sum }_{i , j}^{N} {M}_{ij}^{- 1} {Dc}^{( j )} {c}^{′ ( i )} D ) + \\ & 2 {z}_{0}^{′} J ( I - {\sum }_{i , j}^{N} {M}_{ij}^{- 1} {c}^{( j )} {c}^{′ ( i )} D ) \\ = & 0\end{matrix} \\ {\overline{w}}^{2} = {u}^{′} Qu + {w}_{l}^{2} \qquad ( 13 )$$

u′Qu is the quadratic form in u. For the special case when z₀≈0 or when z₀ is the as designed nominal output vector and goal is to minimize the inner product (z−z₀)′(z−z₀), then v^{(l)}=wₗ²=0 and u=v. Equation (13) rewrites the tolerance requirement of equation (2) as shown in equation (14)

$${u}^{′} Qu \leq {w}_{0}^{2} - {w}_{l}^{2} \qquad ( 14 )$$

Equation (14) represents the inner product of the vector representing the error in the output vector, taking into account the optimum adjustments of the independent compensators. The only assumption made in deriving this equation is that the system behaves linearly, at least for small perturbations. The equality in equation (14) represents a boundary of a region such that if u is withing this region, the tolerancing criterion is met. This defines a bound on the allowed errors, or tolerances, on the individual degrees of freedom that define r. A non-zero v^{(l)} can be thought of as the bias in the allowed errors, that is asymmetric tolerances.

Q can be thought of as derived from D using a process similar to the matrix deflation process. Since Q includes the effect of compensation, some of its eigenvalues will be close to or equal to zero. In fact, QC=0, the space spanned by the compensators is a null space of Q. Matrix Q can be factored as follows.

$$Q = D - {DCM}^{- 1} {C}^{′} D = ( I - {DCM}^{- 1} {C}^{′} ) D = PD \qquad ( 15 )$$

P is idempotent.

$$\begin{matrix}{P}^{2} = ( I - {DCM}^{- 1} {C}^{′} ) ( I - {DCM}^{- 1} {C}^{′} ) \\ = I - 2 {DCM}^{- 1} {C}^{′} + {DCM}^{- 1} {C}^{′} {DCM}^{- 1} {C}^{′} \\ = I - 2 {DCM}^{- 1} {C}^{′} + {DCM}^{- 1} {C}^{′} \\ {P}^{2} = P\end{matrix} \qquad ( 16 )$$

Let the set of eigenvalues of a matrix such as Q be denoted as λ(Q). By virtue of equation (17), Q≥0.

$$\begin{matrix}λ ( Q ) = λ ( PD ) \\ = λ ( PPD ) \\ = λ ( {PDP}^{′} ) \\ λ ( Q ) = λ ( {PJ}^{′} {JP}^{′} )\end{matrix} \qquad ( 17 )$$

Since M=C′J′JC and invertible, it is positive definite hence there also exists a unique positive definite symmetric square root matrix of its inverse, M^{-1/2}. Matrix Q can be rewritten as follows.

$$\begin{matrix}Q = D - {DCM}^{- 1} {C}^{′} D \\ = D - {DCM}^{- \frac{1}{2}} {M}^{- \frac{1}{2}} {C}^{′} D \\ = D - ( {DCM}^{- \frac{1}{2}} ) {( {DCM}^{- \frac{1}{2}} )}^{′} \\ Q = D - {AA}^{′}\end{matrix} \qquad ( 18 )$$

Equation (18) represents the matrix Q as a Restricted Rank modification of matrix D and eigen analysis of such matrix perturbations have been studied previously. If the eigenvector associated with a negligible eigenvalue is predominantly described by a single degree of freedom (uᵢ), then the entire i'th row and column of Q associated with this degree of freedom is also negligible. Such rows and columns and the associated u, can be removed from further consideration. Such degrees of freedom of the system can tolerate large errors and removing them reduces the dimensionality the problem. For the discussion that follows, it is assumed that Q, u, v and v^{(l)} are updated to reflect this change. To avoid any ambiguity, the updated matrix Q will be referred to as R and the updated vector u will be referred to as t.

Equation (19) can be used to calculate the performance of the system under a given perturbation state and choice of compensators. This is tolerance analysis. The matrix R depends only on the system Jacobean J and the set of independent compensators. Simulations involving large Monte Carlo trials can now be performed efficiently using this equation.

$${t}^{′} Rt \leq {w}_{0}^{2} - {w}_{l}^{2} \qquad ( 19 )$$

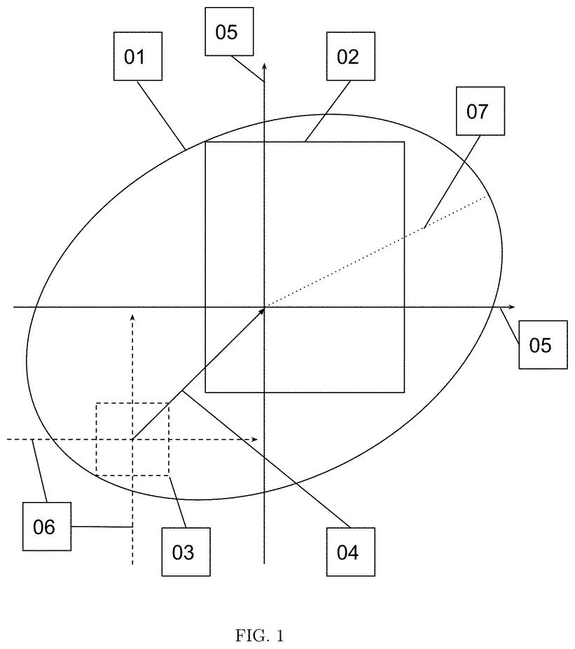

Equation (19) can also be used for automatic tolerance allocation, or tolerance synthesis. R≥0, that is it is a positive semi-definite matrix. It also means that its eigen values are non-negative and in other words the quadratic form in equation (19) is non-negative. A positive definite matrix on the other hand will have all its eigen values strictly positive, that is if R>0, then the equality in equation (19) represents an ellipsoid. The principal axes of this ellipsoid are given by the eigenvectors of R and the length of the line along a principal axes joining the origin to the ellipsoid, or the semi principal axes, is given by \sqrt{(w₀²−wₗ²)/λᵢ}, where λᵢ is the corresponding eigen value. Smaller the eigen value, larger the ellipsoid in this direction. If the tolerance allocation is such that t lies inside of this ellipsoid, then equation (19) is satisfied. Given an upper and lower bound for the individual tolerances, that is if tᵢ ∈[tᵢ^{L}, tᵢ^{U}], the vector t can be anywhere inside of an Orthotope whose sides are defined by these bounds. An Orthotope is the generalization of a cuboid in many dimensions. It must be noted that the Orthotope axes are aligned with the coordinate axes of t, in other words each face of this Orthotope defines a region in which only one degree of freedom (tᵢ) remains constant at its maximum possible value in that orthant. The goal of tolerance allocation is then to make sure that this Orthotope is inside of the ellipsoid. For the case of a 3 dimensional system with only one compensator that is strictly along one dimension, this situation reduces to fitting a 2 dimensional rectangle inside of an ellipse. This situation is shown in FIG. 1. In this figure, the ellipse [1] is from the equality in equation (19), it's semi major axes [7] is given by \sqrt{(w₀²−wₗ²)/λᵢ}, the origin of the coordinate system of tᵢ [5] and vᵢ [6] differ by the vector v^{(l)} [4]. The solid rectangle [2] represents an Orthotope about the origin of tᵢ [5] but whose center of symmetry is not at the origin of tᵢ [5], that is tᵢ^{U}≠−tᵢ^{L}. The dashed rectangle [3] represents an Orthotope that is symmetric and centered at the origin of vᵢ [6].

For the 2 dimensional situation as described in FIG. 1 it should be noted that for the rectangles to represent regions that do not violate equation (19), all corners of the rectangle should be inside of the ellipse [1]. The same argument extends to the case of multi dimensional Orthotope. The corner of an Orthotope is the vector such that the absolute value of its individual components attain the maximum possible value, in that orthant. Making sure that no corner of the Orthotope violate equation (19) should mean that the perturbed system will always be within specification. A good tolerance allocation is such that it allows for large errors in the individual degrees of freedom without violating the tolerancing criterion, that is equation (19). The volume of the Orthotope is one such metric that when maximized, assures that no single degree of freedom is left with tight tolerances, that is with tᵢ^{L} and tᵢ^{U} close to zero. Hence, one algorithm for tolerance synthesis is to find the maximum volume Orthotope that fits inside of the ellipsoid given by equation (19).

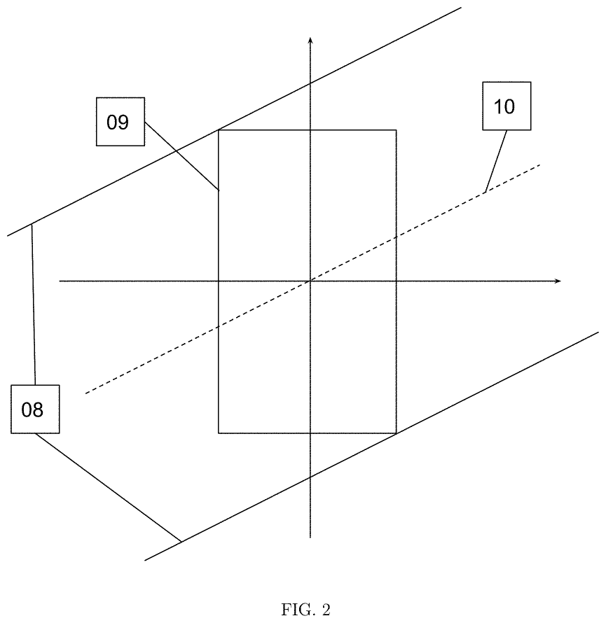

However, since R [symbol] 0 it can have eigen values that are zero. A small eigen value means that the corresponding semi axis of the ellipsoid is large. Three dimensional analogue of such an ellipsoid with one of its eigen values equal to zero is a cylinder with an elliptical cross-section and the axis of this cylinder is along the corresponding eigen vectors. This situation for the 2 dimensional case is shown in FIG. 2. In this figure, the eigen vector along the dashed line [10] has eigen value that is close to zero or equal to zero, and the ellipse becomes parallel lines [8]. The size of the rectangle [9] is being limited by the shorter axis of the ellipse 8. It should be noted that if an eigen vector with negligible eigen value is aligned to one of the degrees of freedom then this is equivalent to having the dashed line [10] parallel to that degree of freedom in FIG. 2. Fitting an Orthotope inside such an aligned and ‘open’ ellipsoid is not a converging situation. However, such a situation cannot arise because such eigen vectors were removed from Q to realize the matrix R.

Consider the problem of allocating centered and symmetric tolerances, that is, about t=0 and such that tᵢ^{U}=−tᵢ^{L}. This is tantamount to finding the optimum symmetric Orthotope centered about t=0 and entirely within the region defined by equation (19). This region is referred to as the valid region from now on instead of an ellipsoid to include the fact that some of the eigen values of R can be zero. For the sake of this discussion, the volume of the Orthotope will be used as a metric to indicate the effectiveness of the allocated tolerances. maximizing the volume results in a balanced distribution of tolerances amongst the various tᵢ. In fact, a quantity directly related to the volume and well behaved is the square of the volume and it will be used as an indicator for tolerance allocation effectiveness. Let this be called V, this is shown in equation (20). Here Nₜ is the number of dimensions in the vector t.

$$V ( t ) = {Π}_{i}^{{N}_{t}} {t}_{i}^{2} \qquad ( 20 )$$

There are 2^{N}^{ₜ} corner in the Orthotope that must be checked to make sure they do not violate equation (19). Symmetry indicates that only half of these corners need to be checked. However, there is a much more efficient method and it involves checking of only a few corners of the Orthotope. Let the unit vector purely along a degrees of freedom tᵢ be designated by \hat{t}ᵢ. Let the eigen vector eₓ of matrix R have the largest eigen value, λₓ. Assume that this eigen value is non-degenerate, that is only one eigen vector is associated with this dominant eigen value and also that none of the components of eₓ is close to zero. The valid region of equation (19) will have the shortest axes along this eigen vector. This eigen vector can obviously be calculated from the full eigendecomposition of the matrix R. However, since it is very likely that only one eigen vector will have the dominant eigen value, the power method can be utilized to efficiently estimate eₓ.

Out of all the corners of the Orthotope, let vector t^{(c)} define a corner of the Orthotope that is in the same orthant as eₓ. With the orientation of t^{(c)} identified, its magnitude can be adjusted till it lies on the surface of the valid region. With this as the starting location, t^{(c)} can be optimized to maximize V(t^{(c)}) while remaining on the surface of the valid region. And this choice of the single corner t^{(c)}, guarantees that none of the other corners extend beyond the valid region.

Let g(t)=t′Rt. With t^{(c)} restricted to the surface of the valid region, any small change in this vector, dt, must be orthogonal to the gradient ∇g(t^{(c)}). At the ideal location, V(t^{(c)}) is maximum and hence it should also not change due to the adjustment dt. In other words, at the optimum location the two gradients must be parallel, that is ∇g(t^{(c)})∥∇V(t^{(c)}).

$$\begin{matrix}∇ g ( t ) = ∇ ( {t}^{′} Rt ) \\ = 2 Rt\end{matrix} \\ and \\ \begin{matrix}∇ V ( t ) = ∇ ( {Π}_{i}^{{N}_{t}} {t}_{i}^{2} ) \\ = V ( t ) \times {t}^{( r )} \vert \vert {t}^{( r )}\end{matrix} \\ where \\ {t}_{i}^{( r )} = \frac{1}{{t}_{i}} \qquad ( 21 )$$

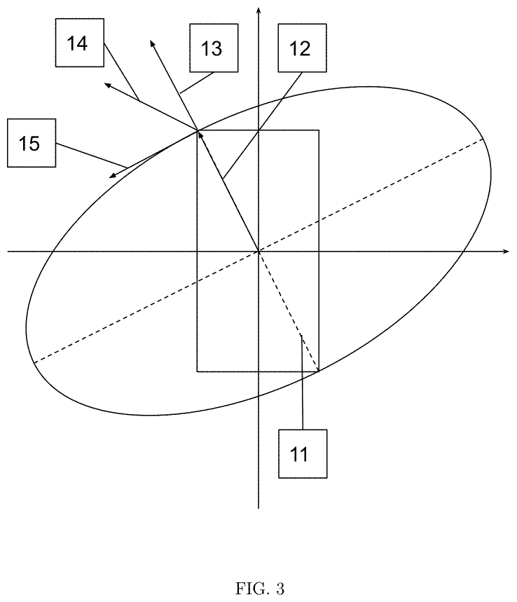

The starting point for this optimization is depicted in FIG. 3. In this figure, the shortest axes [11] of the ellipse is along the vector eₓ and the starting t^{(c)} [12] is on the ellipse and in the same orthant as eₓ. After optimization the unit vector along ∇g [13] must be equal to the unit vector along ∇V [14]. The correction applied to t^{(c)} is in the correction vector direction dt [15] which is orthogonal to unit vector along ∇g [13]. The gradients can be calculated from equations (21). The unit vectors parallel to these gradients can also be calculated. Let these unit vectors be denoted by [symbol] and [symbol] . The optimization can be aimed towards maximizing the Orthotope volume or to make [symbol] = [symbol] , that is to maximize the inner product [symbol] ′ [symbol] . The direction of the vector dt is given by equation (22) and at the optimum solution, dt=0. In fact, a convenient optimization criterion is to minimize the inner product dt′dt.

$$dt = \hat{∇ V} - \hat{∇ g} ( \hat{∇ g} \cdot \hat{∇ V} ) \qquad ( 22 )$$

It should be noted that the choice of the starting corner t^{(c)} is important. If eₓ does not have substantial component along a tᵢ, that is eₓ′ [symbol] 0, that component of the starting corner vector, tᵢ^{(c)}, can be some non-zero value, positive and negative, and both these corners must be included in the set of corners to be monitored during the fitting process. If R does not have a dominant eigenvalue, that is the top eigen values are close, or if the dominant eigenvalue is degenerate, then the correct starting t^{(c)} may not be in the same orthant as eₓ, however, this efficient method involving only a single or only a few corners still results in an Orthotope that is approximately the most optimum with only some corners potentially protruding out of the valid region.

After this optimization, vector t(c) contains the information regarding the optimum tolerance allocation. That is the allowed tolerance along \hat{t}ᵢ should be such that tᵢ ∈[−|tᵢ^{(c)}|,|tᵢ^{(c)}].

The problem of finding an optimum Orthotope that is symmetric but displaced from the origin by a vector t^{(d)} is similar to the previous case when t^{(d)}=0. However, the selection process of the starting corner t^{(c)} lacks the luxury of symmetry. Such a displaced but symmetric Orthotope is represented by the dashed rectangle [3] in FIG. 1. In this case, multiple corners may have to be monitored during optimization. Additionally, the definition of V(t) must change to account for the shift of the Orthotope center. The new volume function definition is shown in equation (23). If ∇g(t^{(d)})=0, this means that t^{(d)} is along an eigen vector with eigen value of zero. In this case the Orthotope can be centered at the origin for fitting and the tolerance range thus arrived at will be also valid at t^{(d)}.

$$V ( t ) = {{Π}_{i}^{{N}_{t}} ( {t}_{i} - {t}_{i}^{( d )} )}^{2} \qquad ( 23 )$$

Eigen values λᵢ, of the symmetric matrix R determine the size of the valid region, smaller the eigen values, larger the corresponding axes of the valid region which in turn relaxes the tolerances allowing for larger error margins in the degrees of freedom of the system. A very good metric then, for the efficacy of the compensators is how small λᵢ are. Because R [symbol] 0, λᵢ≥0 and there are two obvious numbers that serve to indicate how effective the compensators are. These are shown in equation (24) and (25). Equation (24) is well known and equation (25) derives from Schur's inequality.

$$\begin{matrix}{ɛ}^{( s )} = {\sum }_{i} {λ}_{i} = trace ( R ) = {\sum }_{i} {R}_{ii} & ( 24 ) \\ {ɛ}^{( sq )} = {\sum }_{i} {λ}_{i}^{2} = {\sum }_{i , j} {R}_{ij}^{2} & ( 25 )\end{matrix}$$

Either of these two numbers can be used to rapidly ascertain the efficacy of the selected compensators, making it possible to automatically select the best combination of compensators from potential sets of compensators. However, it is possible that the actual effectiveness of the selection depends, to a large extant, on the orientation of the most prominent eigenvector which affects the maximum volume of the Orthotope. Hence, the volume of the estimated Orthotope is the most direct criterion for grading the compensator set choice.

Since matrix R and equation (19) can be evaluated efficiently, this allows for fast pseudo Monte Carlo simulations to extract statistical information on the system. It should be noted that under the assumptions of linearity, this treatment of tolerancing is exact while the Root Sum Square (RSS) approach assumes independence of the DOFs.

It should be noted that the Singular Value Decomposition (SVD) of the system Jacobean J from equation (1) exposes a convenient linear mapping between the vector spaces of v and z, both being represented by a orthonormal basis that is connected by singular values. This treatment of the tolerancing problem remains same when using the orthonormal basis provided by SVD of J. However, the matrix D becomes a diagonal matrix with diagonal elements as the square of the singular values and the valid region/ellipsoid becomes axis aligned, but the Orthotope loses alignment with the axes in general. However, information from SVD can be helpful to identify potential sets of compensators. It is sometimes possible that D is singular, or that it is ill-conditioned and equation (11) must be solved without calculating D⁻¹. In this case v^{(l)} and wₗ² can be calculated using the pseudo inverse of system Jacobean (J⁺) as shown in equation (26) and (27).

$$\begin{matrix}{v}^{( l )} = - {J}^{+} {z}_{0} & ( 26 ) \\ {w}_{l}^{2} = {z}_{0}^{′} ( I - {JJ}^{+} ) {z}_{0} & ( 27 )\end{matrix}$$

The pseudo inverse, J⁺, can be calculated from the SVD of J. The rest of the method still remains the same.

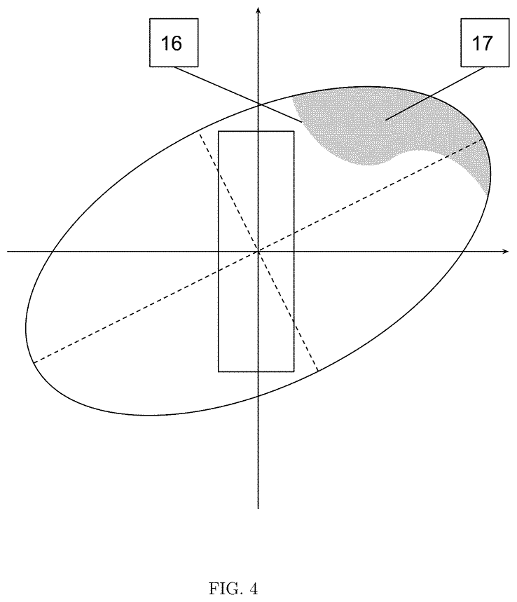

Finally, it should also be noted that if there must be a constraint on the output vector z such that, for example, h^{(z)}(z)<0, then this can be transformed into an equivalent constraint in the input vector space, h^{(v)}(v)<0 and this, along with any other constraints on v, can augment the valid region for further analysis. This situation is described in FIG. 4. In this figure, boundary [16] represent the surface of the region that violates the constraint. And the region [17] is inside the ellipsoid but still violates the constraint, hence is excluded from the ellipsoid.

What is claimed:

1. A computerized method for evaluating the performance of a perturbed system comprising of the following steps: obtaining the system Jacobian matrix J; obtaining the set of compensators; obtaining the input error vector v describing the state of perturbation of the system; obtaining the unperturbed system output vector z₀; utilize equation (10) to evaluate the performance of the perturbed system.

2. Method of claim 1, further comprising the use of equation (13) to evaluate the performance of the perturbed system, wherein the vector u is obtained by shifting the origin of the input vector space by v^{(l)}.

3. Method of claim 2, further comprising the use of equation (19) to evaluate the performance of the perturbed system, wherein vector t and matrix R are obtained by removing the degrees of freedom that are in the null space of matrix Q.

4. Method of claim 3 further comprising the generation of vector t and matrix R by removing the degrees of freedom associated with those rows and the corresponding columns in matrix Q that are negligible.

5. Method of claim 1 further comprising the calculation of required compensator adjustments utilizing equation (7).

6. A computerized method for allocating tolerances by utilizing the size and shape of the largest possible axis aligned Orthotope whose entirety satisfies equation (19).

7. Method of claim 6 further comprising the enforcing of a subset of corners of the Orthotope to satisfy equation (19) in order to make sure that the entire Orthotope satisfies equation (19).

8. Method of claim 7 further comprising the selection of the said subset of corners utilizing the orientation of the dominant eigen vector of matrix R, wherein the vector v^{(l)} is negligible.

9. Method of claim 8 further comprising the selection of a single corner of the Orthotope that is in the same orthant as the dominant eigen vector of matrix R as the sole member of the said subset, wherein no component of the dominant eigen vector is negligible.

10. Method of claim 8 further comprising the inclusion in the said subset of corners of the Orthotope that are in the same orthant as the dominant eigen vector of matrix R when the negligible components of the dominant eigen vector are either a positive or a negative value.

11. Method of claim 6 further comprising the ranking of compensator sets based on the size of the said Orthotope.

12. Method of claim 11 further comprising the ranking of compensator sets utilizing equation (24)

13. Method of claim 11 further comprising the ranking of compensator sets utilizing equation (25)
